(19) United States
(12) Patent Application Publication
(10) Pub. No.: US 2021/0002948 A1
(43) Pub. Date: Jan. 7, 2021

(54) L-SHAPED METAL MESH DOOR AND MANUFACTURING METHOD THEREOF

(71) Applicant: ZBOM HOME COLLECTION CO., LTD., Anhui (CN)

(72) Inventors: Hejun Ye, Anhui (CN); Qiang Xia, Anhui (CN); Anyong Wang, Anhui (CN); Wenjuan Li, Anhui (CN); Yuanyuan Song, Anhui (CN); Dan Wang, Anhui (CN)

(73) Assignee: ZBOM HOME COLLECTION CO., LTD., Anhui (CN)

(21) Appl. No.: 16/321,471

(22) PCT Filed: May 25, 2018
(86) PCT No.: PCT/CN2018/088305

§ 371 Date: Jan. 29, 2019

(30) Foreign Application Priority Data
May 27, 2017 (CN) 201710393816.9

(51) Int. Cl. E06B 3/36; E06B 9/04

(52) U.S. Cl. CPC E06B 3/367; E06B 9/52; E06B 9/04

(57) ABSTRACT

An L-shaped metal mesh door and a manufacturing method thereof are provided. The metal mesh door includes an L-shaped metal mesh and a strip-shaped metal engagement slot. Two metal engagement slots are connected at a corner through L-shaped metal members inserted into a cavity of the metal engagement slot. The metal mesh is embedded in the metal engagement slot. The manufacturing method includes following steps. Manufacturing the metal mesh material by folding a metal mesh material into a 90° L shape. Manufacturing the metal engagement slot chamfering the two metal engagement slots by 45° at the corner, assembling the metal engagement slots through the L-shaped metal members inserted into the square cavity, and then fixing them with screws. Embedding the metal mesh fixedly in the engaging opening of the metal engagement slot, and filling a plastic soft strip in the circular cavity for fixing.

### BACKGROUND OF THE DISCLOSURE

### Field of the Disclosure

The present disclosure relates to the field of furniture manufacturing, and in particular to an L-shaped metal mesh door and a manufacturing method thereof.

### Description of Related Art

Corners of the existing kitchen cabinets are typically roundly formed or made through bevel processing, but as the trend continues to change, it is necessary to make improvement continuously in terms of novelty, materials, and frames. Most of the existing cabinets are opened on single side; the opening is small, and the air permeability is insufficient.

### SUMMARY OF THE DISCLOSURE

### Technical Problem

The purpose of the present disclosure is to solve the above deficiencies of the related art, and to provide an L-shaped metal mesh door and a manufacturing method thereof.

### Technical Solution

The present disclosure is achieved through following technical solutions.

An L-shaped metal mesh door includes a metal mesh and a metal engagement slot. The metal mesh is L-shaped, and the metal engagement slot is strip-shaped. Two metal engagement slots are connected at a corner through L-shaped metal members inserted into a cavity of the metal engagement slot. The metal mesh is embedded in the metal engagement slot.

Preferably, the metal engagement slot is provided with a square cavity. An engaging opening is disposed perpendicular to the square cavity. A circular cavity is provided at a position connecting with the engaging opening. The metal mesh is connected to the metal engagement slot through the engaging opening. The circular cavity is filled with a plastic soft strip for fixing, which makes it more stable and less swaying.

Preferably, the metal mesh has a thickness of 1.2 mm.

A method of manufacturing the L-shaped metal mesh door includes following steps.

(1) The metal mesh material is folded into a 90° L shape to form a metal mesh.

(2) The metal engagement slot is manufactured by chamfering the two metal engagement slots by 45° at the corner, and then assembling through the L-shaped metal members inserted into the square cavity, and then fixing them with screws;

(3) The metal mesh is fixedly embedded in the engaging opening of the metal engagement slot, and the plastic soft strip is filled in the circular cavity for fixing.

Preferably, a surface at a bending portion of the metal mesh described in the step (1) is subjected to an edge and corner processing.

### Advantageous Effect

The advantage effects of the present disclosure are:

This product may be used in the corners of kitchen and other furniture, and has a wide range of applications, providing a new choice of corner cabinets. This product has structure and material that are more novel with good air permeability. An opening direction may be adjusted according to the actual spatial range. The opening is larger than the general cabinet, so it is easy for retrieving and placing objects.

### BRIEF DESCRIPTION OF THE DRAWINGS

FIG. 1 is a perspective view of an L-shaped metal mesh door applied to a cabinet according to the present disclosure.

FIG. 2 is an enlarged cross-sectional view showing a metal engagement slot of the L-shaped metal mesh door of the present disclosure.

### DESCRIPTION OF REFERENCE SIGNS

1. metal mesh; 2. metal engagement slot; 21. square cavity; 22. engaging opening; 23. circular cavity; 3. cabinet; 4. metal frame.

### DESCRIPTION OF EMBODIMENTS

### Optimal Embodiment of the Disclosure

To make the present disclosure more comprehensible, the present disclosure will be further described with reference to the embodiments and the accompanying drawings. The following embodiments only serve to illustrate the present disclosure and should not be construed as a limitation to the present disclosure.

Product Structure

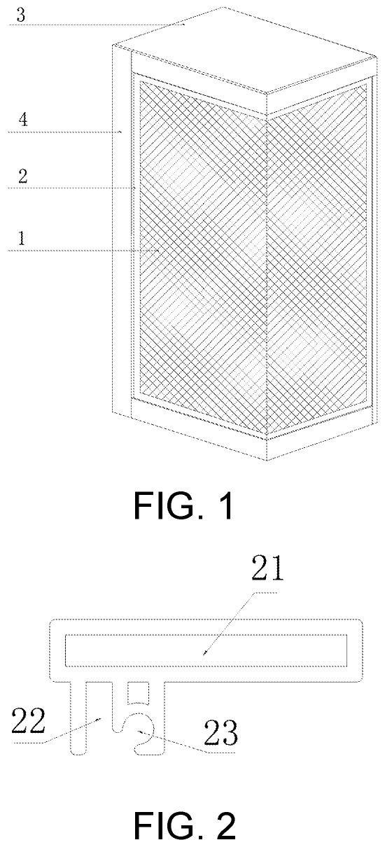

An L-shaped metal mesh door includes a metal mesh 1 and a metal engagement slot 2. The metal mesh 1 is L-shaped, and the metal engagement slot 2 is strip-shaped. Two metal engagement slots 2 are connected at a corner through L-shaped metal members inserted into a cavity of the metal engagement slot 2, and the metal mesh 1 is embedded in the metal engagement slot. When an L-shaped metal mesh door is applied to a cabinet, as shown in FIG. 1, the metal frame 4 is arranged on the cabinet 3 to be mounted with the metal mesh door as a decoration, and a linking process is performed at a bent end opening thereof. A partition plate is used inside the cabinet 3 for division to classify the storage and make full use of the space. The metal mesh 1 is movably connected to the metal frame 4 through the metal connecting member through a shaft. The metal mesh 1, the metal engagement slot 2, the cabinet 3, and the metal frame 4 cooperatively form a closed cubic structure. The metal frame 4 is assembled seamlessly by chamfering two metal strips by 45° at the corner, so that the process is more delicate and more beautiful than direct assembling. The metal mesh 1 is L-shaped and has a thickness of 1.2 mm. As shown in FIG. 2, the metal engagement slot 2 is provided with a square cavity 21. An engaging opening 22 is provided perpendicular to the square cavity 21, and a circular cavity 23 is provided in communication with the engaging opening 22. The metal mesh 1 is connected to the metal engagement slot 2 through the engaging opening 22. The circular cavity 23 is filled with a plastic strip for fixing.

Manufacturing Method

The method for manufacturing the L-shaped metal mesh door applied to the cabinet includes the following steps.

(1) The metal mesh material is folded into a 90° L shape to form a metal mesh 1, and a surface at a bending portion is subjected to an edge and corner processing.

(2) The metal engagement slots 2 are manufactured by chamfering the two metal engagement slots 2 by 45° at the corner, and then assembled through L-shaped metal members inserted the square cavity, and then fixed with screws.

(3) The metal mesh 1 is fixedly embedded in the engaging opening 22 of the metal engagement slot 2, and the plastic soft strip is filled in the circular cavity 23 for fixing.

(4) The metal frame 4 is arranged on the cabinet 3 through barb at back and adhesive glue, and an interior of the cabinet 3 is also fixedly connected with the partition plate parallel to a bottom surface. The metal frame 4 is composed of metal strips. Two metal strips are seamlessly chamfered by 45° at the corner.

(5) The metal frame 4 is provided with a shaft. The metal mesh 1 is movably connected to the metal frame 4 through a metal connecting member through the shaft.

### Embodiments of the Disclosure

Product Structure

An L-shaped metal mesh door includes a metal mesh 1 and a metal engagement slot 2. The metal mesh 1 is L-shaped, and the metal engagement slot 2 is strip-shaped. Two metal engagement slots 2 are connected at the corner through L-shaped metal members inserted into the cavity of the metal engagement slot 2, and the metal mesh 1 is embedded in the metal engagement slot. When the L-shaped metal mesh door is applied to the cabinet, as shown in FIG. 1, the metal frame 4 is arranged on the cabinet 3 to be mounted with the metal mesh door as a decoration, and a linking process is performed at a bent end opening thereof. A partition plate is used inside the cabinet 3 for division to classify the storage and make full use of the space. The metal mesh 1 is movably connected to the metal frame 4 through the metal connecting member through a shaft. The metal mesh 1, the metal engagement slot 2, the cabinet 3, and the metal frame 4 cooperatively form a closed cubic structure. The metal frame 4 is assembled seamlessly by chamfering the two metal strips by 45° at the corner, so that the process is more delicate and more beautiful than direct assembling. The metal mesh 1 is L-shaped and has a thickness of 1.2 mm. As shown in FIG. 2, the metal engagement slot 2 is provided with a square cavity 21. An engaging opening 22 is provided perpendicular to the square cavity, and a circular cavity 23 is provided in connection with the engaging opening 22. The metal mesh 1 is connected to the metal engagement slot 2 through the engaging opening 22. The circular cavity 23 is filled with a plastic strip for fixing.

Manufacturing Method

The method for manufacturing the L-shaped metal mesh door applied to the cabinet includes the following steps.

(1) The metal mesh material is folded into a 90° L shape to form a metal mesh 1, and a surface at a bending portion is subjected to an edge and corner processing;

(2) The metal engagement slots 2 are manufactured by chamfering the two metal engagement slots 2 by 45° at the corner, and then assembled through L-shaped metal members inserted the square cavity, and then fixed with screws;

(3) The metal mesh 1 is fixedly embedded in the engaging opening 22 of the metal engagement slot 2, and the plastic soft strip is filled in the circular cavity 23 for fixing.

(4) The metal frame 4 is arranged on the cabinet 3 through barb at back and adhesive glue, and an interior of the cabinet 3 is also fixedly connected with the partition plate parallel to a bottom surface. The metal frame 4 is composed of metal strips. Two metal strips are seamlessly beveled by 45° at the corner.

(5) The metal frame 4 is provided with a shaft. The metal mesh 1 is movably connected to the metal frame 4 through a metal connecting member through the shaft.

### INDUSTRIAL APPLICABILITY

This product may be used in the corners of kitchen and other furniture, and has a wide range of applications, providing a new choice of corner cabinets. This product has structure and material that are more novel with good air permeability. An opening direction may be adjusted according to the actual spatial range. The opening is larger than the general cabinet, so it is easy for retrieving and placing objects, thus having a certain degree of industrial applicability.

1. An L-shaped metal mesh door, comprising: a metal mesh and a metal engagement slot, the metal mesh being L-shaped, the metal engagement slot being strip-shaped, two metal engagement slots being connected at a corner through L-shaped metal members inserted into a cavity of the metal engagement slot, and the metal mesh being embedded in the metal engagement slot.

2. The L-shaped metal mesh door according to claim 1, wherein the metal engagement slot is provided with a square cavity, and an engaging opening is provided perpendicular to the square cavity, a circular cavity is provided in communication with the engaging opening; the metal mesh is connected to the metal engagement slot through the engaging opening, and the circular cavity is filled with a plastic soft strip for fixing.

3. The L-shaped metal mesh door according to claim 1, wherein the metal mesh has a thickness of 1.2 millimeters.

4. A method of manufacturing the L-shaped metal mesh door according to claim 1, the method comprising following steps:
(1) manufacturing the metal mesh by folding a metal mesh material into a 90° L shape;
(2) manufacturing the metal engagement slot by chamfering the two metal engagement slots by 45° at the corner, assembling the metal engagement slots through the L-shaped metal members inserted into a square cavity, and then fixing with screws; and
(3) embedding the metal mesh fixedly in an engaging opening of the metal engagement slot, and filling a plastic soft strip in a circular cavity for fixing.

5. The method of manufacturing the L-shaped metal mesh door according to claim 4, wherein a surface at a bending portion of the metal mesh in the step (1) is subjected to an edge and corner processing.

6. A method of manufacturing the L-shaped metal mesh door according to claim 2, wherein the method comprising following steps:
(1) manufacturing the metal mesh by folding a metal mesh material into a 90° L shape;
(2) manufacturing the metal engagement slot by chamfering the two metal engagement slots by 45° at the corner, assembling the metal engagement slots through the L-shaped metal members inserted into a square cavity, and then fixing with screws; and
(3) embedding the metal mesh fixedly in the engaging opening of the metal engagement slot, and filling a plastic soft strip in the circular cavity for fixing.

7. A method of manufacturing the L-shaped metal mesh door according to claim 3, wherein the method comprising following steps:
(1) manufacturing the metal mesh by folding a metal mesh material into a 90° L shape;
(2) manufacturing the metal engagement slot by chamfering the two metal engagement slots by 45° at the corner, assembling the metal engagement slots through the L-shaped metal members inserted into a square cavity, and then fixing with screws; and
(3) embedding the metal mesh fixedly in the engaging opening of the metal engagement slot, and filling a plastic soft strip in the circular cavity for fixing.

8. The method of manufacturing the L-shaped metal mesh door according to claim 6, wherein a surface at a bending portion of the metal mesh in the step (1) is subjected to an edge and corner processing.

9. The method of manufacturing the L-shaped metal mesh door according to claim 7, wherein a surface at a bending portion of the metal mesh in the step (1) is subjected to an edge and corner processing.
